(19) United States
(12) Patent Application Publication
(10) Pub. No.: US 2011/0030325 A1
(43) Pub. Date: Feb. 10, 2011

(54) AIR FILTER

(76) Inventors: Ian S. Glanfield, Lasalle (CA); Paul S. Larsen, Goodrich, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 12/849,930

(22) Filed: Aug. 4, 2010

Related U.S. Application Data
(60) Provisional application No. 61/231,772, filed on Aug. 6, 2009.

(51) Int. Cl. B01D 46/52; B29C 67/20; B29C 43/02

(52) U.S. Cl. 55/521; 264/321; 264/241

(57) ABSTRACT

An air filter for a small internal combustion engine. The air filter includes a foam body having at least one flute which increases the outside area of the foam body. The fluid is formed in the foam body by compressing the foam body between two mold halves under pressure and heat until the foam body thermally sets with the formed flute.

### CROSS REFERENCE TO RELATED APPLICATIONS

This application claims priority of U.S. Provisional Patent Application Ser. No. 61/231,772 filed Aug. 6, 2009, which is incorporated herein by reference.

### BACKGROUND OF THE INVENTION

I. Field of the Invention

The present invention relates generally to filters and, more particularly, to an air filter of the type used on small internal combustion engines.

II. Description of Material Art

In small internal combustion engines of the type used for motorcycles, lawnmowers, etc., it is necessary to filter the air intake to the internal combustion engine. The filter removes dust from the inducted air thus protecting the internal components of the internal combustion engine from damage that could be caused by dust or other debris. Such damage includes, for example, damage to the piston, cylinders, and piston rings.

The air filters of the type used for such small internal combustion engines may be generally divided into two groups, namely a paper air filter and a foam air filter. Paper air filters are inexpensive and are constructed from relatively porous paper. The paper prevents dust and other debris from passing through the paper thus allowing the clean air to be inducted into the engine.

The disadvantage of paper filters, however, is that the amount of dust removed by the filter is somewhat limited. Consequently, for optimal performance of the engine it is necessary to frequently replace the paper filter. Since paper filters cannot be cleaned, the old paper filter is simply discarded and replaced with a new one.

Foam air filters, on the other hand, are constructed of a foam material, such as SIF felt foam or reticulated ester foam. Such foam filters are able to not only remove a greater amount of dust from the inducted air to the engine than paper filters, but may also be cleaned and reused. Consequently, even though the cost of a foam filter is greater than a single paper filter, the long term cost of the foam filter is oftentimes less since it may be cleaned and reused whereas paper filters cannot.

One disadvantage of these previously known foam filters, however, is that the foam filters were available only in a geometric block, typically a rectilinear block. The block of film is then positioned within the housing having one side open to the atmosphere and the other side open to the intake for the engine. Thus, inducted air passes through the block which removes dust and debris from the inducted air and so that only filtered air reaches the intake system for the engine.

In high performance applications for small internal combustion engines, such as racing motorcycles, a relatively large volume of air must be inducted into the internal combustion engine for optimal performance. Since the volume of air inducted through the filter is proportional to the area of the filter, it has been previously necessary to provide relatively large foam filters in order to achieve optimal engine performance. This, in turn, increases the cost not only of the filter itself, but also its associated components, such as the filter housing.

### SUMMARY OF THE PRESENT INVENTION

The present invention provides a filter for a small internal combustion engine which overcomes the above-mentioned disadvantages of the previously known devices.

In brief, the present invention provides a filter for a small internal combustion engine having a foam body with at least one flute or pleat (hereinafter collectively referred to as “flute”) formed in it. Preferably, a plurality of flutes are formed in the foam which increases the overall exposed area of the filter. An increase of the area of the filter is directly proportional to the volume of air which may be inducted through the filter during operation of the internal combustion engine.

In order to create the foam filter with at least one flute, a block of foam is positioned in between two mold halves which, together, define at least one flute. The mold halves are compressed together thus sandwiching the foam body in between the mold halves and, simultaneously, the foam is heated. The combination of the heat and the pressure from the mold causes the foam block to conform to the shape of the mold thus forming at least one flute in the foam body. Upon cooling of the foam body, the foam body thermally sets and retains the shape created in the foam body by the mold.

Since the flute in the foam body increases the overall effective area of the filter, a relatively large air flow may be achieved through the foam filter despite a relatively small size of the foam filter.

### BRIEF DESCRIPTION OF THE DRAWING

A better understanding of the present invention will be had upon reference to the following detailed description when read in conjunction with the accompanying drawing, wherein like reference characters refer to like parts throughout the several views, and in which:

FIG. 1 is an exploded view illustrating step during the manufacture of the air filter of the present invention;

FIG. 2 is a sectional view illustrating the air filter sandwiched between two mold halves;

FIG. 3 is a view illustrating a finished air filter;

FIG. 4 is a side view illustrating a modification of the present invention; and

FIG. 5 is a view similar to FIG. 3, but illustrating a modification thereof.

### DETAILED DESCRIPTION OF A PREFERRED EMBODIMENT OF THE PRESENT INVENTION

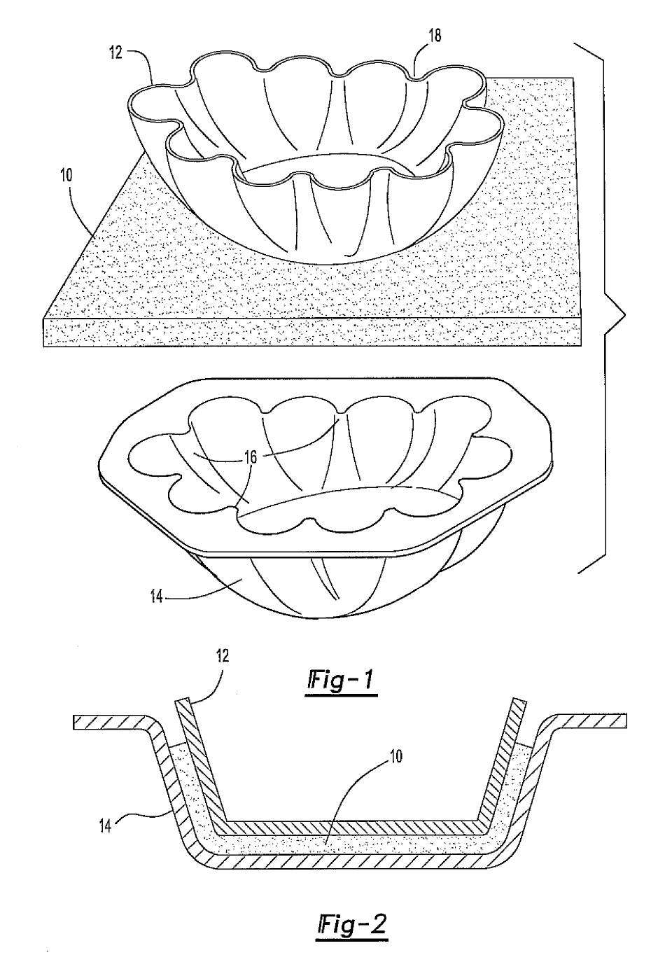

With reference first to FIG. 1, the air filter of the present invention includes a foam body 10 which initially may take any geometric shape. Thus, although the foam body 10 is illustrated in FIG. 1 as having a rectangular shape, other shapes may be used without deviation from the spirit or scope of the invention.

The foam body is constructed of any conventional foam of the type used to form air filters. For example, the foam body 10 may be constructed of SIF felt foam, reticulated ester foam, etc.

In order to construct the air filter, the foam body 10 is positioned in between two mold halves 12 and 14. The mold halves 12 and 14 are complementary in shape and are constructed of a rigid material, such as metal. Additionally, the mold half 14 includes a plurality of ridges 16 which cooperate with complementary valleys 18 formed in the other mold half 12.

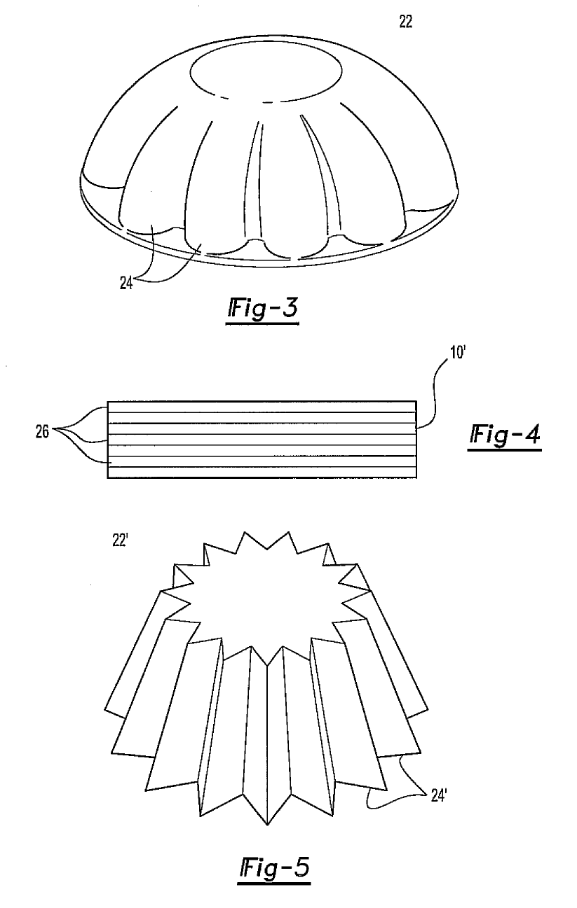

With reference now to FIG. 2, with the foam body 10 sandwiched in between the mold halves 12 and 14, the mold halves 12 and 14 are compressed together. At the same time, the foam body 10 is heated so that the foam body 10 becomes pliable and conforms to the shape of the mold halves 12 and 14. Upon subsequent cooling of the foam body 10, the foam body 10 thermally sets and retains the shape imparted to it by the mold halves 12 and 14 thus forming the air filter 22 as shown in FIG. 3.

It does not matter if the foam body 10 is first heated and then placed in between the mold halves 12 and 14, or first placed between the mold halves 12 and 14 and then heated. Rather, it is only necessary that the foam body 10 be heated sufficiently to become pliable and adapt the shape of the mold halves 12 and 14 in response to both the heat as well as the pressure from the mold halves 12 and 14.

Referring now particularly to FIG. 3, the air filter 22 includes a plurality of flutes 24 which effectively increase the area of the air filter 22. As such, a large volume of air may pass through the air filter 22 despite a relatively small size of the air filter 22.

With reference now to FIG. 4, a modified foam body 10′ is shown. The foam body 10′ differs from the foam body 10 illustrated in FIG. 1 in that the foam body 10′ in FIG. 4 includes a plurality of layers 26 of foam. Consequently, the air filter 22 may contain either a single or multiple layers of foam.

With reference to FIG. 5, a still further example of an air filter 22′ is shown having a plurality of flutes 24′.

It will be understood, of course, that the shapes of the air filters 22 (FIG. 3) and air filter 22′ (FIG. 5) are by way of example only. Air filters constructed in accordance with the present invention may be of any shape provided, of course, that they include at least one flute 24, 24′.

Having thus described my invention, it will be seen that the present invention provides a simple and yet highly effective foam filter for small internal combustion engines with flutes that increase the overall area of the foam filter. As such, the foam filter of the present invention is able to accommodate large air flows despite a relatively small overall size for the air filter itself.

Having described our invention, however, many modifications thereto will become apparent to those skilled in the art to which it pertains without deviation from the spirit of the invention as defined by the scope of the appended claims.

We claim:

1. An air filter for an engine comprising:
a foam body having at least one flute, said flute increasing the outside area of the foam body.

2. The air filter as defined in claim 1 wherein said foam body comprises SIF felt foam.

3. The air filter as defined in claim 1 wherein said body includes a plurality of flutes.

4. The air filter as defined in claim 1 wherein said foam body is heat formed to form said at least one flute.

5. The air filter as defined in claim 1 wherein said foam body comprises reticulated ester foam.

6. The air filter as defined in claim I wherein said foam body comprises a plurality of foam layers.

7. A method of making an air filter for an engine comprising the steps of:
placing a foam body into a mold configured to form at least one flute in said foam body,
heating said foam body to a temperature sufficient for said at least one flute to thermally set in said foam body,
thereafter cooling said foam body.

8. The method as defined in claim 7 wherein said foam body is heated prior to placing said foam body into said mold.

9. The method as defined in claim 7 wherein said foam body is heated after placing said foam body into said mold.

10. The method as defined in claim 7 wherein said heating step comprises the step of blowing hot air through said mold and said foam body.

11. The method as defined in claim 7 wherein said foam body comprises SIF felt foam.

12. The method as defined in claim 7 wherein said foam body comprises reticulated ester foam.

13. The method as defined in claim 7 wherein said foam body comprises at least two layers.

14. The method as defined in claim 7 wherein said mold comprises two mold halves with said foam body positioned between said mold halves, and further comprising the step of compressing said mold halves together during said heating step.
